(19) United States
(12) Patent Application Publication
(10) Pub. No.: US 2026/0370171 A1
(43) Pub. Date: Nov. 19, 2026

(54) WINDING SWITCHING SYSTEM, CONTROL APPARATUS, CONTROL METHOD, AND COMPUTER PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Hiroki SASAKURA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/147,974

(22) PCT Filed: Dec. 14, 2023
(86) PCT No.: PCT/JP2023/044894

§ 371 Date: Jul. 14, 2025

(30) Foreign Application Priority Data
Jan. 17, 2023 (JP) 2023-004994

(51) Int. Cl. H02P 25/18; H02K 11/26; H02K 11/27; H02P 23/14

(52) U.S. Cl. CPC H02P 25/18; H02K 11/26; H02K 11/27; H02P 23/14; H02K 2213/06; H02P 2205/01

(57) ABSTRACT

A winding switching system includes a winding switching unit, a measuring unit, and an abnormality detection unit. The winding switching unit switches a connection state of a plurality of windings of an AC motor that includes the plurality of windings on a stator of each phase. The measuring unit measures a physical quantity relating to rotation of the AC motor. The abnormality detection unit determines whether currents flowing through respective phases of the AC motor are balanced based on the physical quantity measured by the measuring unit.

### CROSS-REFERENCE TO RELATED APPLICATIONS

This application is the U.S. national stage of PCT/JP2023/044894 filed on Dec. 14, 2023, which claims priority of Japanese Patent Application No. JP 2023-004994 filed on Jan. 17, 2023, the contents of which are incorporated herein.

### TECHNICAL FIELD

The present disclosure relates to a winding switching system, a control apparatus, a control method, and a computer program.

### BACKGROUND

JP 2016-088265A discloses a diagnostic system for a vehicle motor that has variable characteristics in which the switching characteristics of windings are changed using switches. The cited document discloses that the diagnostic system detects an abnormality using a switch state sensor that detects an abnormality in a switch, and when an abnormality has been determined, emergency action, such as cutting off the power supply, is taken.

When an abnormality has occurred at a switch that switches windings, the diagnostic system disclosed in JP 2016-088265A detects the abnormality using a switch status sensor that detects the abnormality in the switch and takes emergency action, such as cutting off the power supply. This means that it is necessary to provide a separate switch status sensor.

### SUMMARY

A winding switching system according to an aspect of the present disclosure includes: a winding switching unit for switching a connection state of a plurality of windings of an AC motor that includes the plurality of windings on a stator of each phase; a measuring unit for measuring a physical quantity relating to rotation of the AC motor; and an abnormality detection unit for determining whether currents flowing through respective phases of the AC motor are balanced based on the physical quantity measured by the measuring unit.

The present disclosure can be realized not only as a winding switching system with the characteristic configuration described above, but also as a control apparatus included in a winding switching system, or as a control method for a vehicle motor that has characteristic processing by such control apparatus as steps. The present disclosure can also be realized as a computer program that causes a computer to function as a control apparatus, or a part or all of such control apparatus can be realized as a semiconductor integrated circuit.

### Advantageous Effects

According to an aspect of the present disclosure, an abnormality, such as a relay that switches windings being stuck, can be detected based on whether the motor is balanced.

### BRIEF DESCRIPTION OF DRAWINGS

FIG. 1 depicts an example configuration of a winding switching system according to a first embodiment.

FIG. 2 is a block diagram depicting an example hardware configuration of the control apparatus.

FIG. 3 is a circuit diagram depicting an example configuration of a winding switching apparatus according to the first embodiment.

FIG. 4 is a diagram illustrating an example of an unbalanced state of a motor.

FIG. 5 depicts failure patterns for relays.

FIG. 6 depicts an example simulation of the phase currents, relay currents, and d- and q-axis currents when a motor has become unbalanced.

FIG. 7 depicts another example simulation of phase currents, relay currents, and d- and q-axis currents when a motor has become unbalanced.

FIG. 8 depicts another example simulation of phase currents, relay currents, and d- and q-axis currents when a motor has become unbalanced.

FIG. 9 is a flowchart depicting an example of the winding switching process performed by a control apparatus according to the first embodiment.

FIG. 10 is a circuit diagram depicting an example configuration of a winding switching apparatus according to a second embodiment.

FIG. 11 is a flowchart depicting one example of a winding switching process performed by a control apparatus according to the second embodiment.

FIG. 12 is a flowchart depicting one example of a winding switching process performed by a control apparatus according to a third embodiment.

FIG. 13 is a circuit diagram depicting an example configuration of a winding switching system according to a fourth embodiment.

FIG. 14 is a flowchart depicting one example of a winding switching process performed by the control apparatus according to the fourth embodiment.

FIG. 15 is a circuit diagram depicting an example configuration of a winding switching system according to a fifth embodiment.

FIG. 16 is a circuit diagram depicting an example configuration of a winding switching system according to a sixth embodiment.

FIG. 17 is a flowchart depicting one example of a winding switching process performed by a control apparatus according to the sixth embodiment.

FIG. 18 is a circuit diagram depicting an example configuration of a modification to a winding switching apparatus.

### DETAILED DESCRIPTION OF PREFERRED EMBODIMENTS

Embodiments of the present disclosure will first be listed and described in outline.

In a first aspect, a winding switching system according to an aspect of the present disclosure includes: a winding switching unit for switching a connection state of a plurality of windings of an AC motor that includes the plurality of windings on a stator of each phase; a measuring unit for measuring a physical quantity relating to rotation of the AC motor; and an abnormality detection unit for determining whether currents flowing through respective phases of the AC motor are balanced based on the physical quantity measured by the measuring unit. By doing this, an abnormality in the winding switching unit that switches windings can be detected based on whether the motor is balanced.

In a second aspect, in the winding switching system according to the first aspect, the winding switching unit may switch the connection state of the plurality of windings using a plurality of relays. By doing this, it is possible to detect an abnormality in a winding switching unit that switches windings using relays based on whether a motor is balanced.

In a third aspect, in the winding switching system according to the second aspect, the abnormality detection unit may detect an abnormality that occurs at the plurality of relays by determining whether the currents flowing through the respective phases of the AC motor are balanced. By doing this, it is possible to detect an abnormality in a winding switching unit that switches windings using relays by determining whether the currents flowing through the respective phases of the motor are balanced.

In a fourth aspect, in the winding switching system according to any one of the first to the third aspects, the measuring unit may include a current sensor and measure the currents flowing through the respective phases using the current sensor, and the abnormality detection unit may determine that the currents flowing through the respective phases are not balanced when a current measured by the current sensor exceeds a threshold. By doing this, when a current measured by a current sensor exceeds a threshold, an unbalanced state is determined, and based on this, an abnormality in the winding switching unit can be detected.

In a fifth aspect, in the winding switching system according to the fourth aspect, the current sensor may measure a phase current flowing through the stator of each phase. By doing this, when the phase current measured by a current sensor exceeds a threshold, an unbalanced state is determined, and based on this, an abnormality in the winding switching unit can be detected.

In a sixth aspect, in the winding switching system according to the fourth aspect, at least one of the plurality of relays may be a relay that is set to on in a first connection state and is set to off in a second connection state, and the current sensor may measure the current flowing through the relay (relay current) that is set to on. By doing this, when the relay current measured by a current sensor exceeds a threshold, an unbalanced state is determined, and based on this, an abnormality in the winding switching unit can be detected.

In a seventh aspect, in the winding switching system according to any one of the fourth to the sixth aspects, the AC motor may be a drive motor that drives wheels of a vehicle, and the abnormality detection unit may change the threshold based on a required output of the AC motor. By doing this, by changing the threshold based on the required output of the motor, which is decided by the accelerator opening, the required speed, the required torque, and the like, it is possible to appropriately determine whether the motor is balanced and thereby detect an abnormality in the winding switching unit.

In an eighth aspect, in the winding switching system according to any one of the first to the third aspects, the measuring unit may include a current sensor that measures a phase current flowing through a stator of each phase, and may measure a d-axis current and a q-axis current flowing through the AC motor based on the phase currents, and the abnormality detection unit may compare a target d-axis current, which is a target value of the d-axis current, and a target q-axis current, which is a target value of the q-axis current, with a measured d-axis current, which is a measured value of the d-axis current, and a measured q-axis current, which is a measured value of the q-axis current, and determine that the currents flowing through the respective phases are not balanced when at least one of a first condition that a difference between the target d-axis current and the measured d-axis current is equal to or greater than a first threshold and a second condition that a difference between the target q-axis current and the measured q-axis current is equal to or greater than a second threshold is satisfied. By doing this, it is possible to determine whether the motor is balanced, even in cases where it is difficult to determine whether the motor is balanced based on the phase currents or relay currents.

In a ninth aspect, in the winding switching system according to the eighth aspect, the AC motor may be a drive motor that drives wheels of a vehicle, and the abnormality detection unit may change at least one of the first threshold and the second threshold based on a required output of the AC motor. By doing this, the threshold is changed based on the output required for the motor, which is determined by the accelerator opening, the required speed, the required torque, and the like, so that it is possible to appropriately determine whether the motor is balanced.

In a tenth aspect, in the winding switching system according to the eighth aspect, the abnormality detection unit may determine that the currents flowing through the respective phases are not balanced when at least one of a period during which the first condition is satisfied and a period during which the second condition is satisfied exceeds a reference value. By doing this, even in a situation where noise momentarily occurs, by determining that the state is unbalanced if the difference remains equal to or above the threshold for a predetermined period or more, it is possible to eliminate erroneous judgments and appropriately determine whether the motor is balanced.

In an eleventh aspect, in the winding switching system according to the tenth aspect, the abnormality detection unit may change the reference value based on a rotational speed of a rotor of the AC motor. By doing this, it is possible to appropriately determine whether a motor is balanced even as the rotational speed of a rotor drops and the measured d- and q-axis currents fluctuate slowly.

In a twelfth aspect, in the winding switching system according to any one of the first to the third aspects, the measuring unit may include a voltage sensor that measures a voltage of the plurality of windings. By doing this, it is possible to determine whether the motor is balanced based on voltages at the windings.

In a thirteenth aspect, in the winding switching system according to any one of the first to the third aspects, the measuring unit may include a sensor that measures output torque or a rotational speed of the AC motor. By doing this, it is possible to determine whether the motor is balanced based on the torque or rotational speed of the motor.

In a fourteenth aspect, the winding switching system according to any one of the first to the thirteenth aspects may further include a restoration unit for causing the winding switching unit to restore the connection state before switching when the abnormality detection unit has determined that the currents flowing through the respective phases of the AC motor are not balanced in response to the winding switching unit switching the connection state. By doing this, when an abnormality has been detected at the winding switching unit that switches the windings, the winding switching unit can be restored to the connection state before switching, which enables the motor to continue operating.

In a fifteenth aspect, the winding switching system according to any one of the first to the fourteenth aspects may further include a notification unit that notifies a user of an occurrence of an abnormality when the abnormality detection unit has determined that the currents flowing through the respective phases of the AC motor are not balanced. By doing this, it is possible for the user of the motor to know that the motor is unbalanced.

In a sixteenth aspect, a winding switching system according to another aspect of the present disclosure includes: a winding switching unit for switching a connection state of a plurality of windings of an AC motor capable of switching a connection state of the plurality of windings included on a stator of each phase; a measuring unit for measuring a physical quantity relating to rotation of the AC motor; a balance determination unit for determining whether the currents flowing through the respective phases of the AC motor are balanced based on the physical quantity measured by the measuring unit, and a restoration unit for causing, when a determination by the balance determination unit changes from a determination that the currents flowing through the respective phases are balanced to a determination that the currents flowing through the respective phases are not balanced in response to the connection state having been switched from a first connection state to a second connection state, the winding switching unit to switch the connection state from the second connection state to the first connection state. By doing this, when an abnormality has been detected at the winding switching unit which switches the windings, the winding switching unit can be caused to restore the connection state before switching, which enables the motor to continue operating.

In a seventeenth aspect, a control apparatus according to an aspect of the present disclosure includes: a winding switching unit for switching a connection state of a plurality of windings of an AC motor that includes the plurality of windings on a stator of each phase; a measuring unit including a sensor for measuring a physical quantity relating to rotation of the AC motor; and an abnormality detection unit for determining whether currents flowing through respective phases of the AC motor are balanced based on the physical quantity measured by the measuring unit. By doing this, even if a failure occurs at a relay that switches windings, such as the relay sticking, which causes the motor to become unbalanced, it is possible to restore the motor to a balanced state and continue operating. As a result, an abnormality in the winding switching unit that switches windings can be detected based on whether the motor is balanced.

In an eighteenth aspect, a control method for a winding switching apparatus according to an aspect of the present disclosure includes: a winding switching step of switching a connection state of a plurality of windings of an AC motor that includes the plurality of windings on a stator of each phase; a measuring step of measuring a physical quantity relating to rotation of the AC motor; and an abnormality detection step of determining whether currents flowing through respective phases of the AC motor are balanced based on the physical quantity measured by the measuring step. By doing this, an abnormality in the winding switching unit that switches windings can be detected based on whether the motor is balanced.

In a nineteenth aspect, a computer program according to an aspect of the present disclosure is a computer program used by a control apparatus that controls a winding switching apparatus, the computer program causing a computer to execute: a winding switching step of switching a connection state of a plurality of windings of an AC motor that is capable of switching the connection state of a plurality of windings on a stator of each phase; a measuring step of measuring a physical quantity relating to rotation of the AC motor; and an abnormality detection step of determining whether currents flowing through respective phases of the AC motor are balanced based on the physical quantity measured in the measuring step. By doing this, an abnormality in the winding switching unit that switches windings can be detected based on whether the motor is balanced.

Preferred embodiments of the present disclosure are described in detail below with reference to the accompanying drawings. Note that the embodiments described below can be freely combined, at least in part.

### First Embodiment

### Winding Switching System

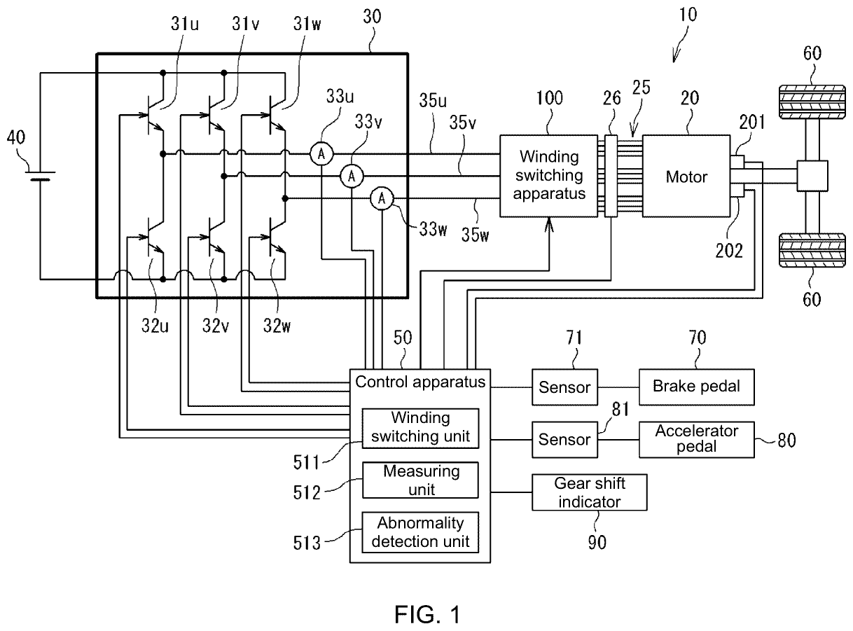

FIG. 1 depicts an example configuration of a winding switching system according to a first embodiment.

A winding switching system 10 is mounted in a vehicle (hereinafter referred to as the “electric vehicle”) that is propelled by a motor, such as an electric vehicle or a plug-in hybrid vehicle. The winding switching system 10 includes a motor 20, a power converter 30, a battery 40, a control apparatus 50, and a winding switching apparatus 100.

The motor 20 is a drive motor that generates a propulsive force for the electric vehicle. In other words, the motor 20 is connected to the wheels 60 and is a drive motor that drives the wheels 60. The motor 20 is driven by three-phase AC power. The motor 20 is a commutator-less AC motor that does not have a commutator and drives the stator to generate a rotating magnetic field which rotates a rotor. Examples of commutator-less AC motors include synchronous motors, reluctance motors, and induction motors.

The battery 40 is a battery for supplying power to drive the motor 20. The battery 40 is a rechargeable battery, and as one example is a lithium ion battery.

The power converter 30 is an inverter that converts DC power supplied from the battery 40 into three-phase AC power. The power converter 30 may also have a function of converting three-phase AC power that is output when the motor 20 is functioning as a generator into DC power to charge the battery 40.

The power converter 30 includes U-phase, V-phase, and W-phase legs. The U-phase leg includes switches 31u and 32u, the V-phase leg includes switches 31v and 32v, and the W-phase leg includes switches 31w and 32w. The switches 31u, 32u, 31v, 32v, 31w, and 32w perform switching to convert DC power into three-phase AC power. As examples, the switches 31u, 32u, 31v, 32v, 31w, and 32w are insulated gate bipolar transistors (IGBTs) or metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W phase extends from the W-phase leg. In the power converter 30, a current sensor 33u is provided on the power line 35u, a current sensor 33v is provided on the power line 35v, and a current sensor 33w is provided on the power line 35w. The current sensor 33u detects the current value of the U-phase current Iu. The current sensor 33v detects the current value of the V-phase current Iv. The current sensor 33w detects the current value of the W-phase current Iw. The current sensors 33u, 33v, and 33w can detect the current values of the currents Iu, Iv, and Iw that flow on the power lines 35u, 35v, and 35w, including both DC and AC components. As examples, the current sensors 33u, 33v, and 33w are DC current sensors, which use Hall sensors, or shunt resistors.

The winding switching apparatus 100 is disposed between the motor 20 and the power converter 30. The power converter 30 and the winding switching apparatus 100 are connected by the power lines 35u, 35v, and 35w, and the winding switching apparatus 100 and the motor 20 are connected by a plurality of power lines 25. The winding switching apparatus 100 switches a connection state of a plurality of windings of the motor 20. The configuration of the winding switching apparatus 100 will be described later. The three-phase AC currents Iu, Iv, and Iw output from the power converter 30 are supplied to the motor 20 via the winding switching apparatus 100.

A measuring apparatus 26 measures a physical quantity relating to rotation of the motor 20. Examples of physical quantities relating to the rotation of a motor include, but are not limited to, the current flowing through each winding of the motor 20, the voltage of each winding, and the torque of the output shaft of the motor 20. The measuring apparatus 26 is provided at an appropriate location for the quantity being measured. When the current or voltage on power lines connecting the winding switching apparatus 100 and the motor 20 is measured, the measuring apparatus 26 is provided on power lines 212u, 221u, 212v, 221v, 212w, and 221w that connect the winding switching apparatus 100 and the motor 20. When measuring the torque and/or rotational speed of the output shaft of the motor 20, the measuring apparatus 26 is provided on the output shaft of the motor 20. Currents are measured using current sensors. As one example, the current sensors are DC current sensors that use Hall sensors. Voltages are measured using voltage sensors. As one example, the voltage sensors are A/D converters. A first terminal of a winding and a reference voltage point (here, the body of the vehicle) are respectively connected to a first terminal and a second terminal out of the input terminals of the AD converter. If a processor 501, described later, has a built-in AD converter, the first terminal and the second terminal of a winding may be connected to the first terminal and the second terminal out of the input terminals of the AD converter of the processor 501. Torque is measured using a torque sensor, which as one example is a strain gauge.

The control apparatus 50 controls the motor 20. In more detail, the control apparatus 50 controls the motor 20 by controlling the power converter 30 and the winding switching apparatus 100. Signal lines extend from the control apparatus 50 to each of the switches 31u, 32u, 31v, 32v, 31w, and 32w, with the control apparatus 50 controlling the on/off timing of the switches 31u, 32u, 31v, 32v, 31w, and 32w. A signal line extends from the control apparatus 50 to the winding switching apparatus 100, with the control apparatus 50 outputting a switching instruction signal to instruct the winding switching apparatus 100 to switch the connection state of the windings.

The control apparatus 50 may be configured to perform vector control of the motor 20. Vector control is a method of resolving the current flowing in the U-phase, V-phase, and W-phase of an AC motor stator into a current component that generates magnetic flux and a current component that generates torque and controlling the respective current components independently. This makes it possible to control the direction and magnitude of the magnetic flux of the rotating magnetic field of the motor as a vector quantity. The current component that generates magnetic flux is sometimes referred to as the “d-axis current”, and the current component that generates torque is sometimes referred to as the “q-axis current”. The currents flowing through the U-phase, V-phase, and W-phase of the motor stator are measured, and the d-axis current and the q-axis current can be found by calculation based on these measured currents. As one example, the control apparatus 50 compares a target d-axis current, which is a target value for the d-axis current, and a target q-axis current, which is a target value for the q-axis current, with a measured d-axis current, which is a measured value of the d-axis current, and a measured q-axis current, which is a measured value of the q-axis current, and controls the power converter 30 so that the measured d-axis current and the measured q-axis current become the target d-axis current and the target q-axis current, respectively. As one example, the target d-axis current and the target q-axis current are determined based on the output (that is, the rotational speed and/or torque) required of the motor 20.

The control apparatus 50 is connected to a sensor 71 that detects a depressed amount of a brake pedal 70, and receives a detection signal that is output from the sensor 71. The control apparatus 50 is also connected to a sensor 81 that detects a depressed amount of an accelerator pedal 80, and receives a detection signal that is output from the sensor 81.

A rotation sensor 201 that detects the rotational speed of the motor 20 and a torque sensor 202 that detects the output torque of the motor 20 are attached to the output shaft of the motor 20. The rotation sensor 201 and the torque sensor 202 are connected to the control apparatus 50. The control apparatus 50 receives a detection signal that is output from the rotation sensor 201 and a detection signal that is output from the torque sensor 202.

The control apparatus 50 is connected to a gear shift indicator 90. The gear shift indicator 90 is an input apparatus for the driver to input a gear shift instruction. As one example, the gear shift indicator 90 is a shift lever. As another example, the gear shift indicator 90 is a switch for the driver to give instructions for an upshift or a downshift. The gear shift indicator 90 outputs a gear shift instruction signal in response to an operation by the driver. The control apparatus 50 receives this gear shift instruction signal that is output from the gear shift indicator 90.

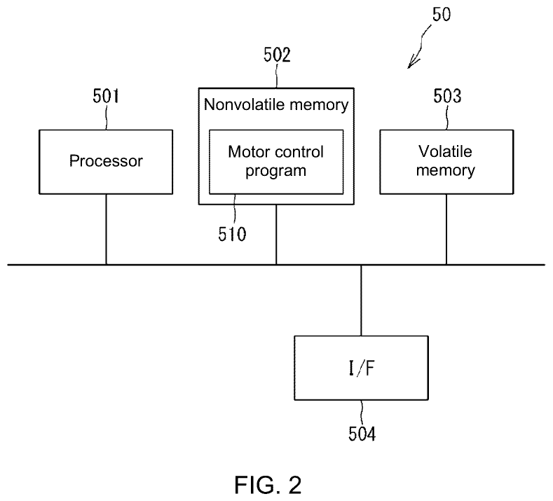

FIG. 2 is a block diagram depicting an example hardware configuration of the control apparatus. The control apparatus 50 includes a processor 501, a nonvolatile memory 502, a volatile memory 503, and an interface (I/F) 504.

As one example, the volatile memory 503 is a semiconductor memory, such as a static random access memory (SRAM) or a dynamic random access memory (DRAM). As examples, the nonvolatile memory 502 is a flash memory, a hard disk, or a read only memory (ROM). The nonvolatile memory 502 stores a motor control program 510, which is a computer program, and data used to execute the motor control program 510. Each function of the control apparatus 50 is realized by the processor 501 executing the motor control program 510. The motor control program 510 can be stored in a recording medium, such as flash memory, a ROM, or a CD-ROM. The processor 501 controls the power converter 30 and the winding switching apparatus 100 using the motor control program 510.

As one example, the processor 501 is a CPU (Central Processing Unit). However, the processor 501 is not limited to a CPU. The processor 501 may be a GPU (Graphics Processing Unit). One example of the processor 501 is a multi-core processor. However, the processor 501 may be a single-core processor. As one example, the processor 501 may be an ASIC (Application Specific Integrated Circuit) or a programmable logic device, such as a gate array or an FPGA (Field Programmable Gate Array). In this case, the ASIC or the programmable logic device is configured to be capable of executing the same processing as the motor control program 510.

The I/F 504 is connected to the rotation sensor 201, the torque sensor 202, the sensor 71, the sensor 81, and the gear shift indicator 90. As one example, the I/F 504 is an input/output interface or a communication interface. The I/F 504 receives a detection signal of the rotational speed of the motor 20 that is output from the rotation sensor 201. The I/F 504 receives a detection signal of the output torque of the motor 20 that is output from the torque sensor 202. The I/F 504 receives a detection signal indicating the depressed amount of the brake pedal that is output from the sensor 71. The I/F 504 also receives a detection signal of the depressed amount of the accelerator pedal that is output from the sensor 81. The I/F 504 receives a gear shift instruction signal that is output from the gear shift indicator 90.

### Configuration of Winding Switching Apparatus

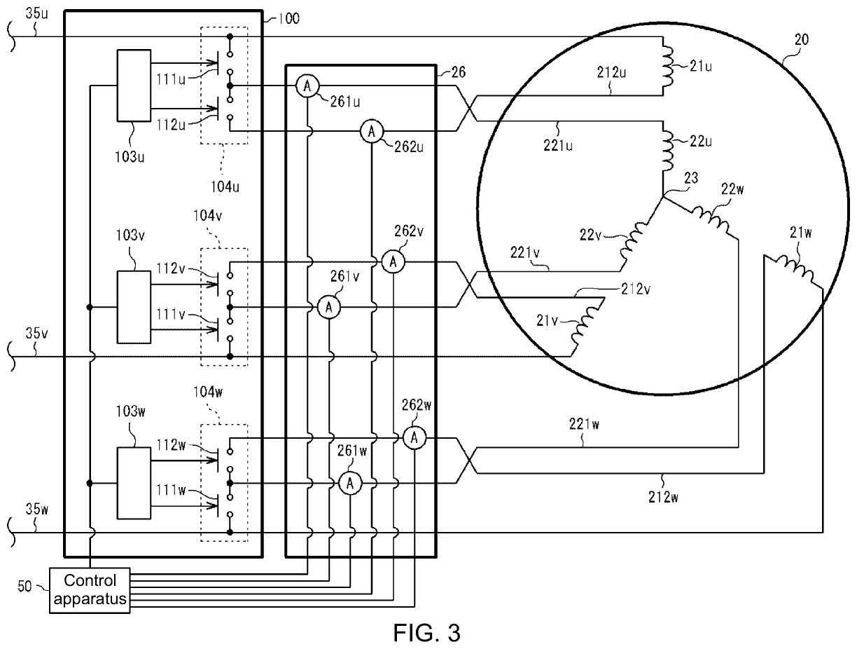

FIG. 3 is a circuit diagram depicting an example configuration of the winding switching apparatus according to the first embodiment. The motor 20 includes a plurality of windings 21u, 22u, 21v, 22v, 21w, and 22w. The windings 21u and 22u correspond to the U-phase, the windings 21v and 22v correspond to the V-phase, and the windings 21w and 22w correspond to the W phase. However, the number of windings for each phase is not limited to two, and may be three or more. The windings 22u, 22v, and 22w are connected at a neutral point 23.

The winding switching apparatus 100 switches the connection state of the windings 21u, 22u, 21v, 22v, 21w, and 22w in each phase between a state where two windings are connected in series and a state where one winding is connected. The winding switching apparatus 100 includes control circuits 103u, 103v, and 103w and switching circuits 104u, 104v, and 104w. Hereinafter, the state where two windings are connected in series may be referred to as the “series state”, and the state where one winding is connected may be referred to as the “single state”.

The switching circuits 104u, 104v, and 104w switch the connection state of the windings 21u, 22u, 21v, 22v, 21w, and 22w between the series state and the single state under the control of the control apparatus 50. The series state is one example of a “first connection state”, and the single state is one example of a “second connection state”.

The following describes the connection relationship between the winding switching apparatus 100, the power line 35u, and the motor 20 for the U-phase. Since the connection relationship for the V-phase and the W phase are the same, description thereof is omitted.

The power line 35u is connected to a first terminal of the winding 21u. The power line 212u extends from a second terminal of the winding 21u. The power line 221u extends from a first terminal of the winding 22u.

The switching circuit 104u includes a relay 111u and a relay 112u. The relay 111u and the relay 112u may be mechanical (electromagnetic) relays for example, but are not limited to this and may be semiconductor relays. Each relay is divided into an input side and an output side. The output side of the relay includes a switch that controls whether the current is on or off, with the switch being set to on or off by inputting a predetermined control signal into the input side. In the case of a mechanical relay, the input side is composed of an electromagnetic coil, for example. The output side is composed of a mechanical switch including a movable piece and a fixed piece. The movable piece and the fixed piece each have a contact. The movable piece is pulled (energized) in one direction by an elastic body, such as a spring, and is pulled (attracted) in the other direction by the electromagnetic coil. A Type A relay is constructed so that the contacts are in a conductive state when the electromagnetic coil has pulled the movable piece in the other direction. In the case of a semiconductor relay, as one example, the input side is composed of a light-emitting diode, and the output side is composed of a light-receiving element, a MOSFET, or an IGBT.

The power line 35u extends inside the winding switching apparatus 100. Inside the winding switching apparatus 100, the power line 35u branches at a midpoint and is connected to the first terminal of the relay 111u. The second terminal of the relay 111u is connected to the first terminal of the relay 112u. The power lines 212u, 221u, and 222u extend from the motor 20 into the winding switching apparatus 100. The power line 221u extending from the winding 22u is connected to a junction between the second terminal of the relay 111u and the first terminal of the relay 112u. The power line 212u that extends from the winding 21u is connected to the second terminal of the relay 112u.

When the relay 111u is in the off state and the relay 112u is in the on state, the winding 21u and the winding 22u are in the series state. When the relay 111u is in the on state and the relay 112u is in the off state, the winding 21u is in the single state.

A signal line that extends from a control circuit 103u is connected to the respective input sides (electromagnetic coil sides) of the relay 112u and the relay 111u. A signal line that extends from the control apparatus 50 is connected to the control circuit 103u. This signal line is used for communication of an instruction indicating one of the connection states of the windings. This signal may be referred to hereinafter as a “switching instruction”. As one example, a low level of the signal line indicates the series state and a high level indicates the single state. Alternatively, data communication may be performed via the signal line to transmit and receive information indicating which relay is to be set to on or off.

The control circuit 103u performs on/off control of the relay 112u and the relay 111u by individually applying control signals to the input sides of the relay 112u and the relay 111u. In more detail, when the control circuit 103u has received, from the control apparatus 50, a switching instruction to switch the connection state of the windings 21u and 22u from the series state to the single state, the control circuit 103u sets the relay 111u to the on state and sets the relay 112u to the off state. When the control circuit 103u has received, from the control apparatus 50, a switching instruction to switch the connection state of the windings 21u and 22u from the series state to the single state, the control circuit 103u sets the relay 111u to the off state and sets the relay 112u to the on state.

As one example, the control circuit 103u is constructed of a plurality of logic circuits (such as AND circuits, NOT circuits, and latch circuits). As another example, the control circuit 103u is composed of a processor. The control circuit 103u is composed of a single-chip microcomputer, for example. The control circuit 103u may be constructed of a programmable logic device, such as an ASIC or an FPGA.

The measuring apparatus 26 is provided on the power line connecting the winding switching apparatus 100 and the motor 20, for example. As one example, the measuring apparatus 26 includes a phase current sensor and a relay current sensor. Aphase current sensor 261u is provided on the power line 221u, and a relay current sensor 262u is provided on the power line 212u. The phase current sensor 261u measures the current flowing through the U-phase when the windings 21u and 22u are in the series state and in the single state. Hereinafter, the current measured by the phase current sensor may be referred to as the “phase current”. The phase current sensor 261u sends a signal or information indicating the value of the measured current to the control apparatus 50.

The relay current sensor 262u measures the current flowing through the power line 212u connected to the second terminal of the relay 112u. When the connection state of the windings 21u and 22u is switched from the series state to the single state, the relay current sensor 262u measures the current on the power line 212u that the relay 112u, which is to be set to off, is about to cut off. Hereinafter, the current measured by the relay current sensor may be referred to as the “relay current”. The relay current sensor 262u sends a signal or information indicating the value of the measured current to the control apparatus 50.

In the same way, for the V-phase, a phase current sensor 261v is provided on the power line 221v, and a relay current sensor 262v is provided on the power line 212v. For the W phase also, a phase current sensor 261w is provided on the power line 221w, and a relay current sensor 262w is provided on the power line 212w. Note that although an example is described where the measuring apparatus 26 is provided on the power line connecting the winding switching apparatus 100 and the motor 20, the measuring apparatus 26 may be provided inside the winding switching apparatus 100 or inside the motor 20.

The description will now return to FIG. 1 and describe the functions of the control apparatus 50. The control apparatus 50 includes the functions of a winding switching unit 511, a measuring unit 512, and an abnormality detection unit 513. The processor 501 executes the motor control program 510 to realize the functions of the winding switching unit 511, the measuring unit 512, and the abnormality detection unit 513.

### Winding Switching Unit

The winding switching unit switches the connection states of a plurality of windings in an AC motor, which includes the plurality of windings on a stator for each phase. The winding switching unit switches the connection states of the windings using a plurality of relays. At least one out of the plurality of relays is set to on in a first connection state and is set to off in a second connection state.

In more detail, the winding switching unit 511 switches the connection states of the windings 21u, 22u, 21v, 22v, 21w, and 22w for each phase between a state where two windings are connected in series and a state where one winding is connected. The winding switching apparatus 100 includes the control circuits 103u, 103v, and 103w and the switching circuits 104u, 104v, and 104w. The winding switching unit 511 causes the switching circuits 104u, 104v, and 104w to switch the connection state of the windings 21u, 22u, 21v, 22v, 21w, and 22w between the series state and the single state. In more detail, the winding switching unit 511 transmits switching instructions to the control circuits 103u, 103v, and 103w. As one example, a switching instruction indicates the series state when the switching instruction is at a low level, and indicates the single state when the switching instruction is at a high level.

### Measuring Unit

The measuring unit 512 measures a physical quantity relating to the rotation of the AC motor. One example of a physical quantity relating to the rotation of the motor is the current flowing through each phase of the motor 20. The measuring unit 512 includes current sensors, and measures the currents flowing through the respective phases using the current sensors. Each current sensor measures the phase current flowing through the stator of that phase. In more detail, for the U-phase, the measuring unit 512 measures the phase current flowing through the stator of the U-phase by way of the phase current sensor 261u measuring the current flowing through the power line 221u.

Current sensors also measure the currents flowing through the switch of a relay. In more detail, for the U-phase, the measuring unit 512 measures the relay current of the U-phase by way of the relay current sensor 262u measuring the current flowing through the power line 212u.

The phase current sensor 261u and the relay current sensor 262u then send signals or information indicating the measured current values to the control apparatus 50. The measuring unit 512 of the control apparatus 50 receives the signals or information indicating the measured current values and measures a physical quantity relating to the rotation of the AC motor. The same applies to the V-phase and the W-phase.

### Abnormality Detection Unit

The abnormality detection unit 513 determines whether the currents flowing through each phase of the AC motor are balanced based on the physical quantity measured by the measuring unit 512. When the currents flowing through each phase of the motor 20 are not balanced, this means that the equilibria of the currents flowing through the U, V, and W phases differ from each other. When the currents flowing through each phase of the motor 20 are not balanced, this state may also be referred to as the “unbalanced state”, and when the currents flowing through each phase of the motor 20 are balanced, this state may also be referred to as the “balanced state”.

### Unbalanced State of Motor

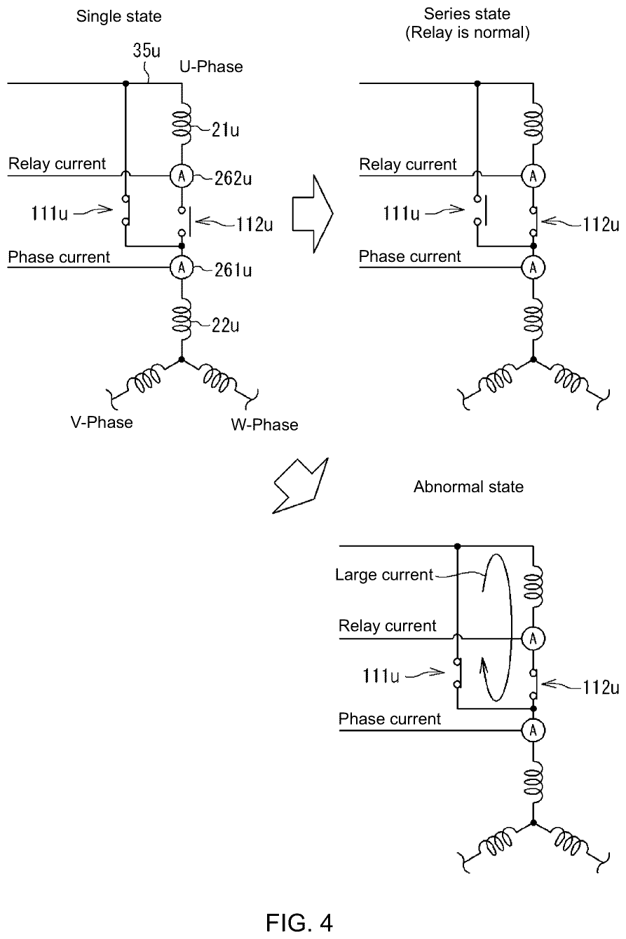

FIG. 4 is a diagram illustrating an example of an unbalanced state of the motor 20. FIG. 4 depicts the windings 21u and 22u and the relays 111u and 112u of the U-phase that are referred to in the following description. It is assumed here that the state before the winding switching apparatus 100 switches the connection state of the windings is the single state. At this time, the relay 111u is set to on and the relay 112u is set to off (illustrated as “single state” in FIG. 4). Next, when the winding switching apparatus 100 has switched the connection state of the windings from the single state to the series state, the relay 111u is set to off, and if the relays are normal, the relay 112u is set to on (illustrated as “series state” in FIG. 4).

However, if the relay 111u has failed and become stuck so as to be fixed to on, the relay 112u will be set to on but the relay 111u will not be set to off and will continue to be on (illustrated as “abnormal state” in FIG. 4). This results in the ends of the winding 21u being short-circuited. Since the rotor of the motor 20 is rotating, the winding 21u will function as a generator and an abnormally large current will flow through the winding 21u. Based on this abnormally large current, the abnormality detection unit 513 determines that the motor 20 is in an unbalanced state.

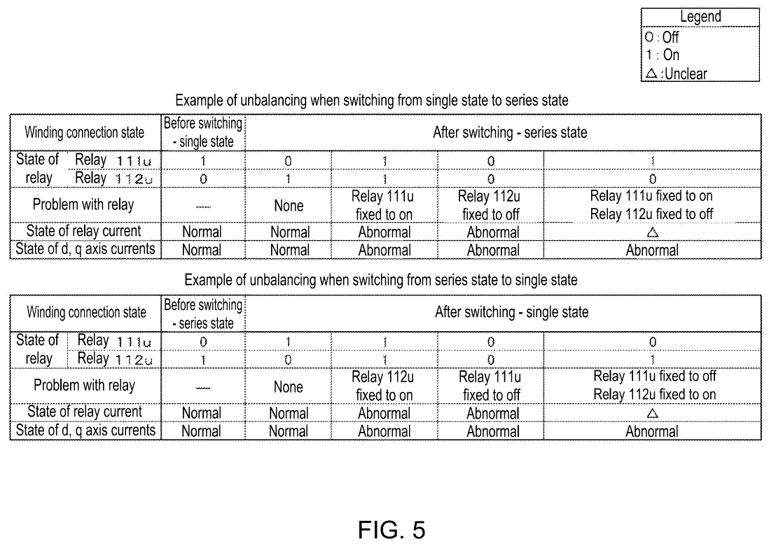

FIG. 5 depicts different patterns for relay failures. Conceivable patterns for a failure at a relay include a case where the output contacts become stuck or the like and remain connected (that is, the relay is fixed in the on state) and a case where the electromagnetic coil of a relay becomes disconnected or the like and the contacts on the output side remain open (that is, the relay is fixed in the off state). In FIG. 5, off is expressed as “0” and on is expressed as “1”. FIG. 5 depicts a case where the connection state of the windings is switched from the single state to the series state and a case where the connection state of the windings is switched from the series state to the single state. Note that FIG. 5 also depicts the states of the relay currents and the states of the d-axis and q-axis currents.

When the connection state of the windings is switched from the single state to the series state, the following types of failure can occur:
(1) the relay 111u is fixed to on, and both the relays 111u and 112u are set to on so that the winding 21u is short-circuited;
(2) the relay 112u is fixed to off, and both the relays 111u and 112u are set to off so that current no longer flows through the U-phase windings 21u and 22u; and
(3) the relay 111u is fixed to on and the relay 112u is fixed to off, so that even though the V-phase and W-phase windings have been switched to the series state, the U-phase remains in the single state.

When the connection state of the windings is switched from the series state to the single state, the following types of failure can occur:
(1) the relay 112u is fixed to on, and both the relays 111u and 112u are set to on so that the winding 21u is short-circuited;
(2) the relay 111u is fixed to off, and both the relays 111u and 112u are set to off so that current no longer flows through the U-phase windings 21u and 22u; and
(3) the relay 111u is fixed to off and relay 112u is fixed to on, so that although the V-phase and W-phase windings have been switched to a single state, the U-phase remains in the series state.

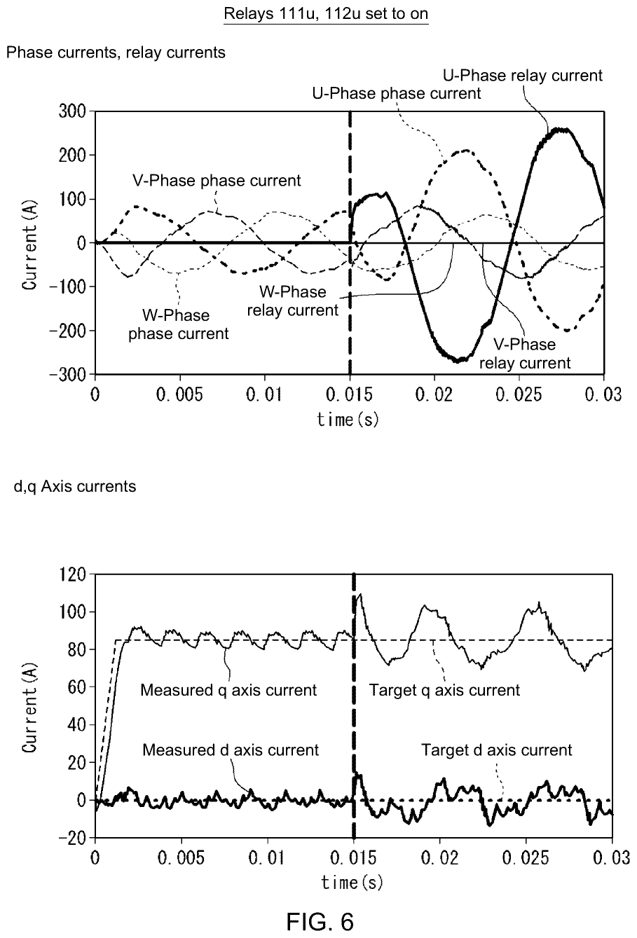

FIGS. 6, 7, and 8 depict example simulations of phase currents, relay currents, and d- and q-axis currents when any of the relays that change the connection state of a winding has failed and the motor 20 has become unbalanced. In each of the illustrated examples, the connection state of the windings is switched at the timing indicated as 0.015 s on the time(s) axis. Although the currents are in the normal state during the period from 0 s to 0.015 s on the time axis, from 0.015 s on the time axis onward, one of the currents becomes abnormal.

When a relay has failed and the motor 20 becomes unbalanced, one of the relay current, the phase current, and the d-axis and q-axis currents will have an abnormal value. The abnormality detection unit 513 detects this abnormal value and determines that the motor 20 is unbalanced.

### When a Phase Current or Relay Current is Abnormal

FIG. 6 depicts a case where the U-phase relays 112u and 111u are both in the on state when the connection state has changed from the single state to the series state. In this case, as described earlier, both ends of the winding 21u are short-circuited, and since the rotor of the motor 20 is rotating, the winding 21u will function as a generator and a large current will circulate through the winding 21u. This large current is larger than the relay current that flows in the normal state. Since the windings 21u and 22u are connected in series in the normal state, the relay current and the phase current will flow with substantially the same current.

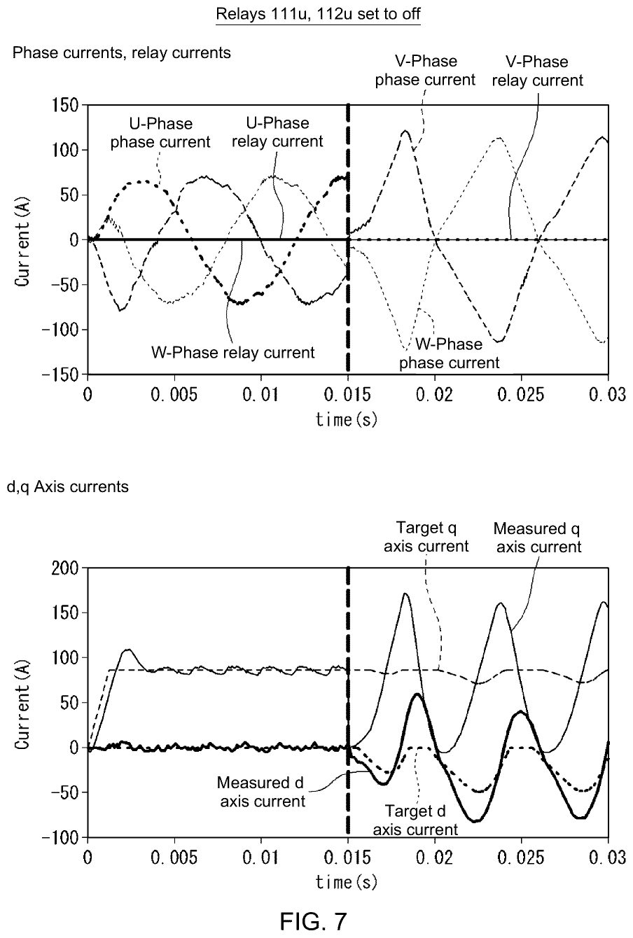

FIG. 7 depicts a case where the U-phase relays 112u and 111u are both in the off state when the connection state has changed from the single state to the series state. In this case, no phase current or relay current flows for the U-phase. On the other hand, larger currents than normal flow through the V and W-phases.

The abnormality detection unit 513 determines whether the currents flowing through each phase of the motor 20 are in a balanced state based on the signal indicating this large current measured by the measuring unit 512. In more detail, the abnormality detection unit 513 determines that the currents flowing through the respective phases are not balanced when a current measured by a current sensor exceeds a threshold.

As one example, if a phase current measured by the phase current sensor 261v or the phase current sensor 261w exceeds a threshold, or if a relay current measured by the relay current sensor 262v or the relay current sensor 262w exceeds a threshold, it is determined that the motor 20 is in an unbalanced state. Note that, since no current flows through the U-phase under normal conditions, the abnormality detection unit 513 may determine that the motor 20 is in an unbalanced state based on this current.

The abnormality detection unit 513 may change the threshold based on the output required of the motor 20. This is because the currents that flow during normal operation will increase in keeping with the required motor output. By doing this, it is possible to appropriately determine whether the motor 20 is in the balanced state. If the motor 20 is a drive motor that drives the wheels of the vehicle, the required output is determined based on the accelerator opening, the speed required by the vehicle, and the torque required by the vehicle, for example.

By doing this, the abnormality detection unit 513 determines whether the currents flowing through the respective phases are balanced.

### When d and q Axis Currents are Abnormal

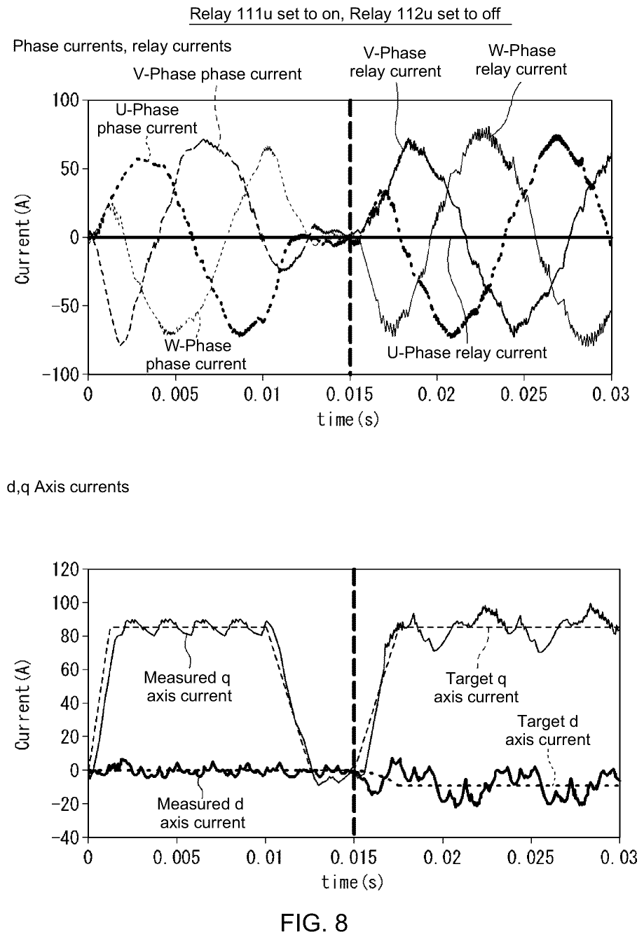

FIG. 8 depicts a case where the U-phase relay 111u is on and the U-phase relay 112u is off when the connection state has changed from the single state to the series state. In this state, the V-phase and W-phase are in the series state, but only the U-phase is in the single state. In this case, the phase currents of the U, V, and W phases are approximately the same as the currents in a normal state. This means that it is difficult to determine whether the motor 20 is in a balanced state based on the phase currents alone. On the other hand, the d- and q-axis currents that flow clearly differ from the currents in the normal state. Accordingly, an unbalanced state can be determined based on the d- and q-axis currents found by calculation from the phase currents flowing through the U, V, and W phases.

In more detail, the abnormality detection unit 513 compares a target d-axis current, which is the target value of the d-axis current, and a target q-axis current, which is the target value of the q-axis current, with the measured d-axis current, which is the measured value of the d-axis current, and the measured q-axis current, which is the measured value of the q-axis current, and when at least one of a first condition that the difference between the target d-axis current and the measured d-axis current is equal to or greater than a first threshold and a second condition that the difference between the target q-axis current and the measured q-axis current is equal to or greater than a second threshold is satisfied, determines that the currents flowing through the respective phases are not balanced. The first threshold and the second threshold may be the same value or may be different values.

When the measured d-axis current and the measured q-axis current have been found by calculation based on the phase currents of the U-phase, V-phase, and W-phase measured by the measuring unit 512, there is the risk of the thresholds being momentarily exceeded. For this reason, it is possible to determine that the currents flowing through the phases are not balanced when at least one of a period where the first condition is satisfied and a period where the second condition is satisfied exceeds a reference value. If the abnormality detection unit 513 determines that the motor 20 is in an unbalanced state when a period where the d-axis current or the q-axis current exceeds the threshold has continued for longer than a predetermined period, it is possible to more appropriately determine whether the motor 20 is in a balanced state.

The reference value may also be changed based on the rotational speed of the rotor of the motor 20. Since the d- and q-axis currents fluctuate in response to the rotation of the rotor, the d- and q-axis currents will fluctuate slowly as the rotational speed of the rotor of the motor 20 decreases. For this reason, it is preferable to lengthen the predetermined period as the rotational speed of the rotor decreases. This makes it possible to appropriately determine whether the motor 20 is in a balanced state.

As one example, the first threshold and the second threshold may be changed according to the output required of the motor 20. This is because the currents flowing in a normal state will increase in keeping with the required motor output. This makes it possible to appropriately determine whether the motor 20 is in the balanced state. If the motor 20 is a drive motor that drives the wheels of a vehicle, the required output is determined based on the accelerator opening, the speed required by the vehicle, and the torque required by the vehicle, for example.

By operating as described above, the abnormality detection unit 513 determines whether the currents flowing through the phases are balanced.

### Operation of the Winding Switching System

Next, the operation of the winding switching apparatus 100 will be described. The control apparatus 50 executes a winding switching process by the processor 501 executing the motor control program 510.

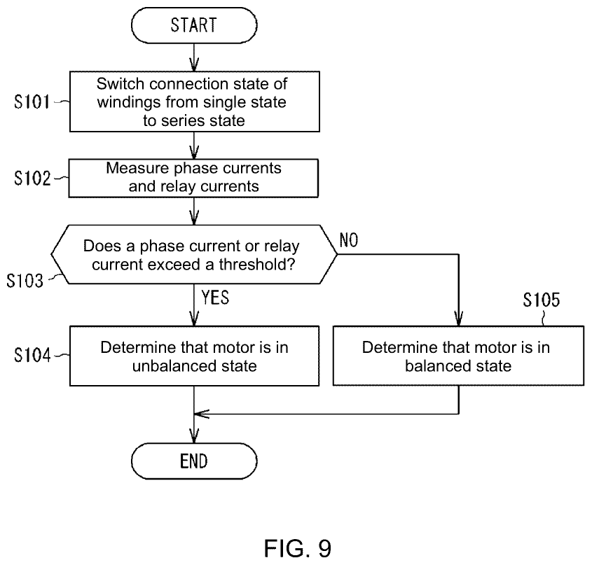

FIG. 9 is a flowchart depicting an example of the winding switching process performed by the control apparatus according to the first embodiment.

### When a Relay is Fixed to On

In this case, at the start of the winding switching process for example, the windings 21u, 22u, 21v, 22v, 21w, and 22w of the motor 20 are connected in the single state. When the connection state is the single state, the relays 112u, 112v, and 112w are set to off, and the relays 111u, 111v, and 111w are set to on. For this reason, in keeping with the types of failure of the relays 111u and 112u, if the relay 111u is stuck for example, the relay will be on in the same way as in the normal state, which means that the motor 20 will operate normally so long as the motor 20 is operating in the single state. In the following description, it is assumed that the V-phase and W-phase relays 111v, 111w, 112v, and 112w can be set to on and off as normal.

### Step S101

First, the winding switching unit 511 switches the connection state of the plurality of windings of an AC motor including a plurality of windings on the stator of each phase (step S101). As one example, the winding switching unit 511 switches the connection state of the windings from the single state to the series state. In more detail, the winding switching unit 511 transmits a switching instruction to switch the connection states of the windings 21u, 22u, 21v, 22v, 21w, and 22w from the single state to the series state to the control circuits 103u, 103v, and 103w. The control circuit 103u, which has received the switching instruction to switch the connection state from the single state to the series state, sets the relay 112u to on and the relay 111u to off. In the same way, the control circuit 103v sets the relay 112v to on and the relay 111v to off. The control circuit 103w sets the relay 112w to on and the relay 111w to off. The processing then proceeds to step S102. In this example, since the relay 111u is stuck, both the relays 111u and 112u are set to on. As a result, both ends of the winding 21u are short-circuited, which causes a large relay current which circulates through the winding 21u to flow as depicted in FIG. 6.

### Step S102

Next, the measuring unit 512 measures a physical quantity relating to the rotation of the AC motor (step S102). In more detail, the phase current sensor 261u measures the phase current and transmits a signal indicating the value of the phase current to the control apparatus 50. The relay current sensor 262u measures the relay current and transmits a signal indicating the value of the relay current to the control apparatus 50. In this example, the relay current sensor 262u measures the large current circulating through the winding 21u and transmits a signal indicating the value of this current. The control apparatus 50 receives this signal and the measuring unit 512 measures the phase current and the relay current, which are physical quantities relating to the rotation of the motor 20. The processing then proceeds to step S103.

### Step S103

Next, the abnormality detection unit 513 determines whether the currents flowing through the respective phases of the motor 20 are balanced based on the physical quantities measured by the measuring unit 512. In more detail, the abnormality detection unit 513 compares the phase current or the relay current measured by the measuring unit 512 with a threshold (step S103). If the threshold is exceeded (YES in step S103), the processing proceeds to step S104. On the other hand, if the threshold is not exceeded (NO in step S103), the processing proceeds to step S105.

In this example, the control apparatus 50 receives a signal indicating the large current value circulating through the winding 21u. The abnormality detection unit 513 of the control apparatus 50 compares the received relay current value with a threshold. Since the relay current value indicates a large current value, the threshold is exceeded and the abnormality detection unit 513 determines that the motor 20 is in an unbalanced state.

### Step S104

If the phase current or relay current exceeds the threshold, the abnormality detection unit 513 determines that the currents flowing through the phases of the motor 20 are not balanced (step S104). The winding switching process then ends.

### Step S105

On the other hand, if the phase current and the relay current do not exceed the threshold, the abnormality detection unit 513 determines that the currents flowing through the respective phases of the motor 20 are balanced (step S105), and ends the winding switching process.

By operating as described above, it is possible to determine whether the motor is in a balanced state.

### When a Relay is Fixed to Off

As one example, it is assumed that the electromagnetic coil of the relay 111u has become disconnected or the like and the relay 111u is fixed to off. In this case, the motor 20 will operate normally so long as the windings are connected in series. In the series state, the relay 112u is set to on and the relay 111u is set to off, but when focusing on the relay 111u alone, there is no difference between this failure state and the normal state. In the initial state, it is assumed that the windings are in the series state.

### Step S101

Next, it is assumed that the winding switching unit 511 switches the connection state of the windings from the series state to the single state (step S101). The relay 112u is set to off, and the relay 111u is set to on. If the relays 112u and 111u are normal, a predetermined current will flow through the U-phase winding 22u. However, since the relay 111u is fixed to off, the U-phase relays 112u and 111u are both set to off, and no current flows through the U-phase windings. On the other hand, as depicted in FIG. 7, a large current flows through the V-phase and W-phase windings 22v and 22w.

### Step S102

Next, the measuring unit 512 measures the phase currents of the U-phase, V-phase, and W-phase of the motor 20 using the phase current sensors 261u, 261v, and 261w. In more detail, the phase current sensor 261u transmits a signal indicating that the current value is zero to the control apparatus 50. The phase current sensors 261v and 261w transmit signals indicating large current values in the V-phase and W-phase to the control apparatus 50. When the control apparatus 50 receives such signals, the measuring unit 512 measures the phase currents. The processing then proceeds to step S103.

### Step S103

Next, the abnormality detection unit 513 determines whether the currents flowing through the respective phases of the motor 20 are balanced based on the physical quantities measured by the measuring unit 512. Since the value of the phase current of the V-phase indicates a large current and exceeds the threshold (YES in step S103), the abnormality detection unit 513 determines that the motor 20 is in an unbalanced state (step S104). Alternatively, the abnormality detection unit 513 may make this determination based on the phase current of the W-phase. As another alternative, the abnormality detection unit 513 may make the determination based on the phase current of the U-phase. Since the phase current of the U-phase is zero as described earlier, the current value indicated by the signal that is output by the phase current sensor 261u exceeds the threshold, so that the abnormality detection unit 513 determines that the motor 20 is in an unbalanced state. On the other hand, if the threshold is not exceeded (NO in step S103), the abnormality detection unit 513 determines that the motor 20 is in a balanced state (step S105).

### When Two Relays are No Longer Operating

In this case, it is assumed, for example, that the relay 111u is stuck and fixed to on. Also it is assumed that the electromagnetic coil of the relay 112u has become disconnected so that the relay 112u is fixed to off. In this case, the motor 20 will operate normally so long as the connection state of the windings is the single state. This is because the relay 111u is set to on and the relay 112u is set to off in the single state, so that there is no difference between this fault and the normal operation state. As the initial state, it is assumed that the connection state of the windings is the single state.

### Step S101

Next, the winding switching unit 511 switches the connection state of the windings from the single state to the series state (step S101). The control circuit 103u sets the relay 112u to on and attempts to set the relay 111u to off. However, since the relay 112u is fixed to off and the relay 111u is fixed to on, the connection state of the U-phase windings does not switch to the series state and remains in the single state. On the other hand, the connection states of the V-phase and the W-phase windings are switched to the series state. In this connection state, the phase current or the relay current does not become significantly large as depicted in FIG. 8. When focusing on the d-axis and q-axis currents however, such currents fluctuate significantly. The processing then proceeds to step S102.

### Step S102

After this, the measuring unit 512 measures the phase currents of the U-phase, V-phase, and W-phase of the motor 20 using the phase current sensors 261u, 261v, and 261w, and outputs a signal indicating the measured phase currents. The control apparatus 50 receives this signal and the measuring unit 512 measures the phase currents (step S102). The processing then proceeds to step S103.

### Steps S103 to S105

Next, the abnormality detection unit 513 compares the target d-axis current, which is the target value of the d-axis current, and the target q-axis current, which is the target value of the q-axis current, with the measured d-axis current, which is the measured value of the d-axis current, and the measured q-axis current, which is the measured value of the q-axis current, and determines, when at least one of a first condition that the difference between the target d-axis current and the measured d-axis current is equal to or greater than a first threshold and a second condition that the difference between the target q-axis current and the measured q-axis current is equal to or greater than a second threshold is satisfied (YES in step S103), that the currents flowing through the respective phases are not balanced (step S104). On the other hand, when a threshold is not exceeded (NO in step S103), it is determined that the motor 20 is in a balanced state (step S105).

In more detail, the control apparatus 50 receives signals indicating the phase currents of the U-phase, V-phase, and W-phase from the phase current sensors 261u, 261v, and 261w, and finds the measured d-axis current and the measured q-axis current by calculation based on the received phase currents of the U-phase, V-phase, and W-phase. The difference between the target d-axis current and the measured d-axis current and the difference between the target q-axis current and the measured q-axis current are then found by calculation, and if at least one of the difference for the d-axis current exceeds a first threshold and the difference for the q-axis current exceeds a second threshold (YES in step S103), the abnormality detection unit 513 determines that the motor 20 is in an unbalanced state (step S104). If neither the first condition nor the second condition is satisfied (NO in step S103), the abnormality detection unit 513 determines that the motor 20 is in a balanced state (step S105).

The abnormality detection unit 513 may also determine that the currents flowing through the respective phases are not balanced when at least one of the period where the first condition is satisfied and the period where the second condition is satisfied exceeds a reference value.

In more detail, the abnormality detection unit 513 firstly determines whether the period during which the difference between the target d-axis current and the measured d-axis current is equal to or greater than a first threshold is longer than a predetermined period. The abnormality detection unit 513 secondly determines whether the period during which the difference between the target q-axis current and the measured q-axis current is equal to or greater than a second threshold is longer than a predetermined period. When at least one of the first determination and the second determination is satisfied (YES in step S103), the abnormality detection unit 513 determines that the motor 20 is in an unbalanced state (step S104). On the other hand, when neither the first determination nor the second determination is satisfied (NO in step S103), the abnormality detection unit 513 determines that the motor 20 is in a balanced state (step S105).

### Second Embodiment

The measuring unit of a winding switching system according to the second embodiment includes a voltage sensor, which measures the voltages of the plurality of windings. Although the second embodiment differs from the first embodiment in the configuration of the measuring apparatus 26, the other configurations are the same. Description of configurations that are the same as in the first embodiment is omitted, and only the different parts will be described, with the same reference numerals being used for configurations that are the same.

### Configuration of Winding Switching Apparatus

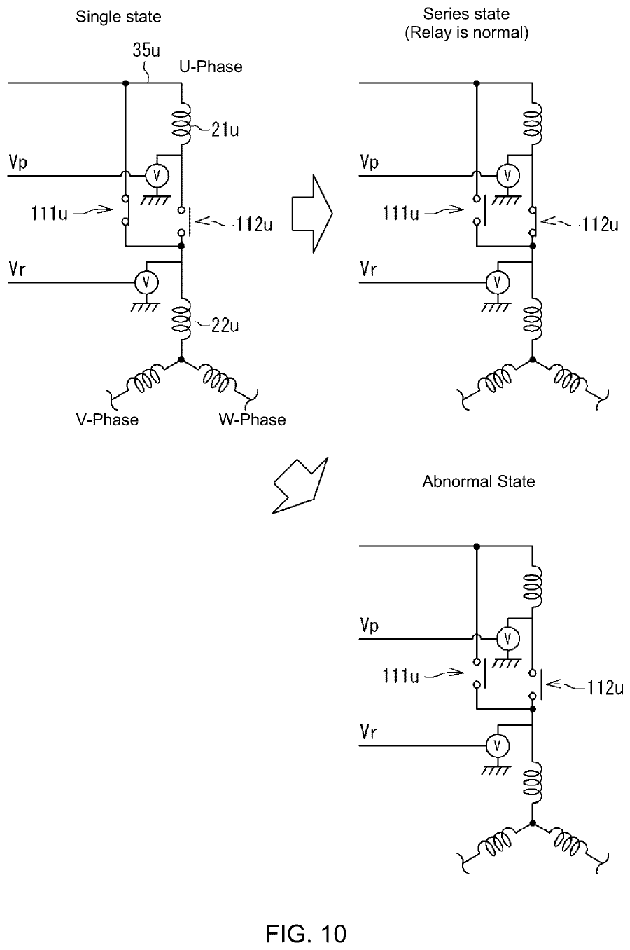

FIG. 10 is a circuit diagram depicting an example configuration of a winding switching apparatus according to the second embodiment. Although only the U-phase is depicted in detail, the V-phase and the W-phase are the same. In this example, a voltage Vpu between the power line 212u, which connects the winding 21u and the relay 112u, and a reference voltage point and a voltage Vru between the power line 221u, which connects the relay 112u and the winding 22u, and the reference voltage point are measured. The reference voltage point is the body of the vehicle, for example. Although the measurement points are the same as in the first embodiment, the present embodiment is not limited to this.

The voltages are measured using voltage sensors. As one example, the voltage sensors are A/D converters. A first terminal out of the inputs of the A/D converter is connected to the power line 212u and a second terminal is connected to the reference voltage point. The voltage sensors are not limited to A/D converters, and may be photocouplers or the like.

### Operation of the Winding Switching Apparatus

Next, the operation of the winding switching apparatus 100 will be described. The control apparatus 50 executes the winding switching process by the processor 501 executing the motor control program 510.

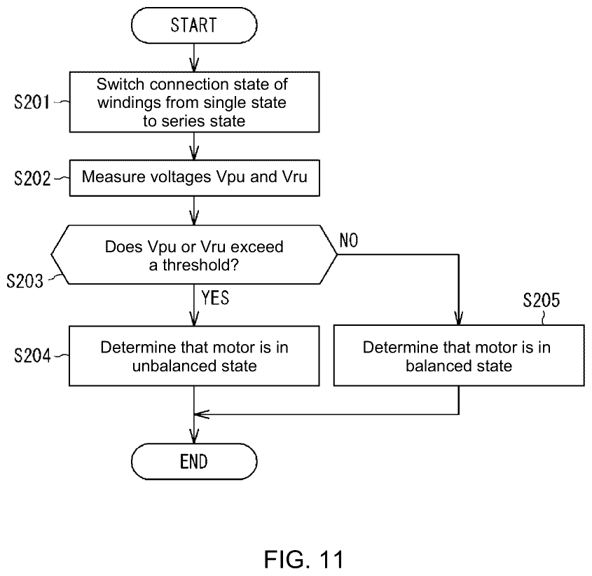

FIG. 11 is a flowchart depicting one example of a winding switching process performed by the control apparatus according to the second embodiment.

In this case, at the start of the winding switching process for example, it is assumed that the windings 21u, 22u, 21v, 22v, 21w, and 22w of the motor 20 are connected in the single state. When the connection state is the single state, the relays 111u, 111v, and 111w are set to on and the relays 112u, 112v, and 112w are set to off. For this reason, in keeping with the types of failure of the relays 112u and 111u, if for example the electromagnetic coil of relay 112u is disconnected and fixed to off, the relay will be set to off which is no different from the normal state, and so long as the motor 20 is operating in the single state, the motor 20 will operate normally. In the following description, it is assumed that the V-phase and W-phase relays 111v, 111w, 112v, and 112w can be set to on and off as normal.

### Step S201

First, the winding switching unit 511 switches the connection state of the windings from the single state to the series state. In more detail, the control apparatus 50 transmits a switching instruction to the control circuits 103u, 103v, and 103w to switch the connection state of the windings 21u, 22u, 21v, 22v, 21w, and 22w from the single state to the series state (step S201). The control circuit 103u, which has received a switching instruction to switch the connection state from the single state to the series state, sets the relay 112u to on and sets the relay 111u to off. In the same way, the control circuit 103v sets the relay 112v to on and the relay 113v to off. The control circuit 103w sets the relay 112w to on and the relay 113w to off. The processing then proceeds to step S202.

In this example, since the relay 112u is fixed to off, the relays 112u and 111u are set to off. In the normal state, the relay 112u is set to on so that the windings 21u and 22u are connected in series. The voltage Vpu or Vru, which is the voltage at the midpoint of the windings 21u and 22u that are connected in series, will be approximately half the voltage between the power line 35u and the neutral point 23. However, since the relay 112u is fixed to off, Vpu or Vru will become a completely different voltage from the voltage in the normal state. As one example, if the rotor is a permanent magnet, voltages will be generated in the windings 21u and 22u by the rotating permanent magnet, and such voltages will be completely different from the voltages in the normal state.

In addition, since the relay 112u is set to on in the normal state, the voltage between the first and second terminals on the output side (the contact side) of the relay 112u is zero. However, since the relay 112u is fixed to off, a voltage greater than zero will be generated between the first and second terminals on the output side (contact side) of the relay 112u.

### Step S202

Next, the measuring unit 512 measures a physical quantity relating to the rotation of the motor 20 (step S202). In the second embodiment, the measuring unit 512 measures the physical quantity relating to the rotation using a voltage sensor that measures the voltages of a plurality of windings. The voltage sensor measures Vpu and Vpr and transmits a signal indicating Vpu and Vpr to the control apparatus 50. When the control apparatus 50 receives this signal, the measuring unit 512 measures Vpu and Vpr. The processing then proceeds to step S203.

### Steps S203 to S205

Next, the abnormality detection unit 513 determines whether the motor 20 is balanced (steps S203 to S205).

In more detail, the abnormality detection unit 513 compares Vpu and Vpr measured by the measuring unit 512 with a threshold, and if the threshold is exceeded (YES in step S203), the abnormality detection unit 513 determines that the motor 20 is unbalanced (step S204), and then ends the winding switching process.

On the other hand, if the threshold is not exceeded (NO in step S203), the abnormality detection unit 513 determines that the motor 20 is in a balanced state (step S205) and then ends the winding switching process.

In this example, since Vpu and Vpr are values that are completely different from the values during normal operation, the threshold is exceeded and the abnormality detection unit 513 determines that the motor 20 is unbalanced. Note that this determination may also be based on the difference between Vpu and Vru. When doing this, the voltage across both ends of the relay 112u is measured. When the relay 112u is set to on, the voltage across both ends of the relay 112u is zero. On the other hand, when the relay 112u is set to off, the voltage across both ends of the relay 112u is greater than zero.

By operating as described above, it is possible to determine whether a motor is in a balanced state using a voltage sensor.

### Third Embodiment

The measuring unit of a winding switching system according to the third embodiment measures the torque or rotational speed of the output shaft of an AC motor using a sensor that measures torque or rotational speed. Although the third embodiment differs from the first embodiment in the configuration of the measuring apparatus 26, the other configurations are the same. Description of configurations that are the same as in the first embodiment is omitted and only the different parts will be described, with the same reference numerals being used for configurations that are the same. A case where the sensor is a torque sensor is described below.

### Operation of Winding Switching Apparatus

Next, the operation of the winding switching apparatus 100 will be described. The control apparatus 50 executes the winding switching process by the processor 501 executing the motor control program 510.

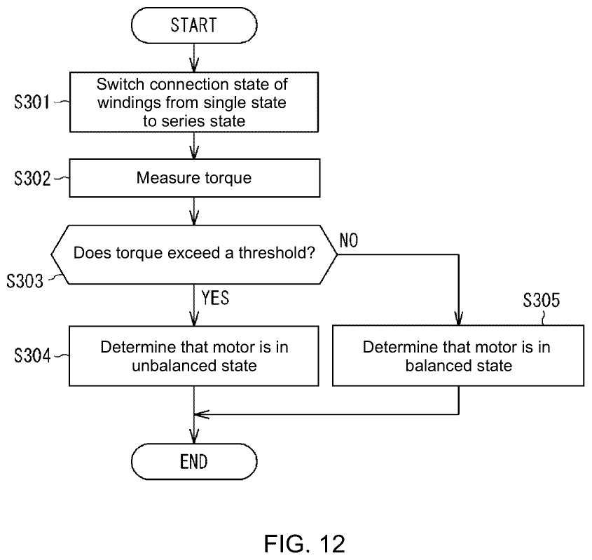

FIG. 12 is a flowchart depicting one example of a winding switching process performed by the control apparatus according to the third embodiment.

In this case, at the start of the winding switching process for example, it is assumed that the windings 21u, 22u, 21v, 22v, 21w, and 22w of the motor 20 are connected in the single state. When the connection state is the single state, the relays 112u, 112v, and 112w are set to off, and the relays 111u, 113v, and 113w are set to on. For this reason, in keeping with the types of failure of the relays 111u and 112u, if for example the electromagnetic coil of the relay 112u is disconnected so that the relay 112u is fixed to off, the relay will be set to off in the same way as in the normal state, which means that the motor 20 will operate normally so long as the motor 20 is operating in the single state. In the following description, it is assumed that the V-phase and W-phase relays 112v, 112w, 113v, and 113w can be set on and off as normal.

### Step S301

First, the winding switching unit 511 switches the connection state of the windings from the single state to the series state. In more detail, the control apparatus 50 transmits a switching instruction to switch the connection state of the windings 21u, 22u, 21v, 22v, 21w, and 22w from the single state to the series state to the control circuits 103u, 103v, and 103w (step S301). The control circuit 103u that received the switching instruction to switch the connection state from the single state to the series state sets the relay 112u to on and the relay 111u to off. In the same way, the control circuit 103v sets the relay 112v to on and the relay 113v to off. The control circuit 103w sets the relay 112w to on and the relay 113w to off. The processing then proceeds to step S302.

In this example, since the relay 112u is fixed to off, the relays 112u and 111u are both set to off. As a result, no current flows through the windings 21u and 22u of the U-phase. On the other hand, although the windings V and W are in the series state and large currents flow through them, excitation also occurs. This distorts the rotating magnetic field generated by the U-phase, the V-phase, and the W-phase windings, and the torque generated by the rotor, which is subjected to torque from the rotating magnetic field, greatly fluctuates. As one example, the torque will strongly pulsate in synchronization with the rotation of the rotor.

### Step S302

Next, the measuring unit 512 measures the state of the motor 20 (step S302). In more detail, the torque of the output shaft of the motor 20 is measured by the torque sensor 202, and a signal indicating the torque is transmitted to the control apparatus 50. In this example, a signal indicating a strongly pulsating torque is transmitted for example. When the control apparatus 50 receives this signal, the measuring unit 512 measures the torque. The processing then proceeds to step S303.

### Step S303 to Step S305

Next, the abnormality detection unit 513 determines whether the motor 20 is balanced.

In more detail, the measuring unit 512 receives a signal indicating the torque of the output shaft of the motor 20, which is output by the torque sensor. The abnormality detection unit 513 compares the value of the signal indicating the torque measured by the measuring unit 512 with a threshold (step S303), and if the value exceeds the threshold (YES in step S303), the abnormality detection unit 513 determines that the motor 20 is unbalanced (step S304) and then ends the winding switching process.

On the other hand, if the threshold is not exceeded (NO in step S303), the abnormality detection unit 513 determines that the motor 20 is in a balanced state (step S305), and then ends the winding switching process.

In more detail, the torque exhibits a constant value in a normal state. On the other hand, in an abnormal state, the torque will greatly pulsate at a frequency corresponding to the rotational speed of the motor 20. As one example, a frequency component corresponding to the rotational speed is extracted from the measured torque value and the intensity is measured. This intensity is then compared with a threshold. If the threshold is exceeded, the abnormality detection unit 513 may determine that the motor 20 is unbalanced.

By operating as described above, it is possible to determine whether the motor is in a balanced state using a torque sensor, and an abnormality in a winding switching unit that switches the windings can be detected.

Note that although a torque sensor has been described above, the physical quantity relating to the rotation of the motor 20 may be measured by a rotation sensor 201 that measures the rotational speed of the output shaft of the motor 20. This is because when the torque greatly pulsates in synchronization with the rotation of the rotor, the rotational speed of the output shaft of the motor 20 will also fluctuate during one revolution of the output shaft.

### Fourth Embodiment

The winding switching system according to the fourth embodiment further includes a restoration unit. When the abnormality detection unit has determined that the currents flowing through the respective phases of the AC motor are not balanced in response to the winding switching unit switching the connection state, this restoration unit causes the winding switching unit to restore the connection state before the switch.

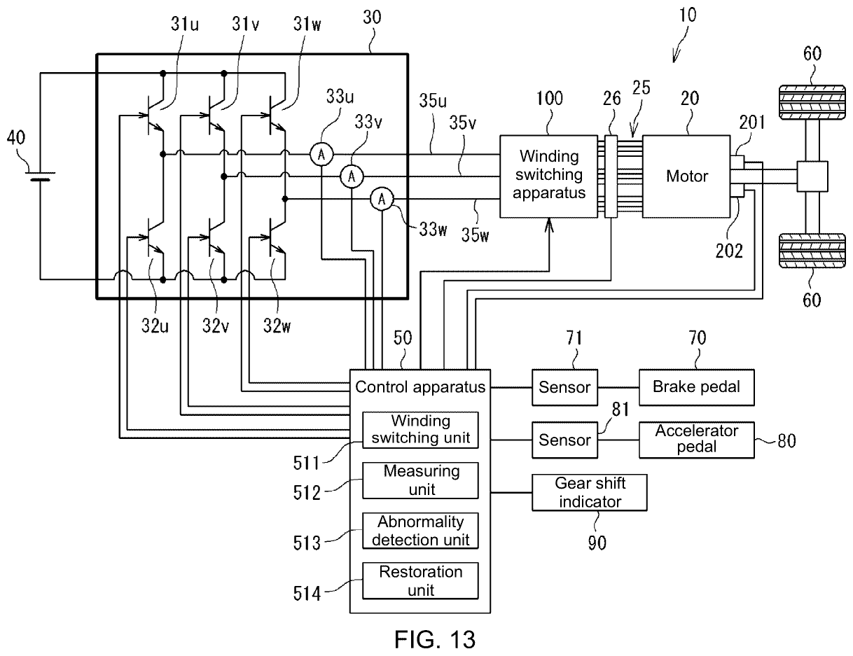

FIG. 13 is a circuit diagram depicting an example configuration of a winding switching system according to the fourth embodiment. The fourth embodiment differs from the first embodiment in that a restoration unit 514 is further provided, but the other configurations are the same. Description of configurations that are the same as those in the first embodiment is omitted and only different parts will be described, with the same reference numerals being used for configurations that are the same.

### Functions of Restoration Unit

As one example, it is assumed that the motor 20 was operating normally before the connection state is switched and that the winding switching unit 511 has switched the connection state from the single state to the series state. Here, if the abnormality detection unit 513 has determined that the motor 20 is unbalanced, the restoration unit 514 causes the winding switching unit 511 to switch back to the single state before the switch. If, when the winding switching unit 511 has conversely switched the connection state from the series state to the single state, the abnormality detection unit 513 has determined that the motor 20 is unbalanced, the restoration unit 514 causes the winding switching unit 511 to switch the connection state back to the series state before the switch.

That is, the motor 20 is operating normally when in the connection state before the connection state is switched. This means that by having the restoration unit 514 cause the connection state of the windings to be restored to the connection state before the switch, the motor 20 will continue to operate even if some type of failure has occurred at a relay. If the motor 20 is a drive motor that drives the wheels of a vehicle, the vehicle can continue to run.

### Operation of the Winding Switching System

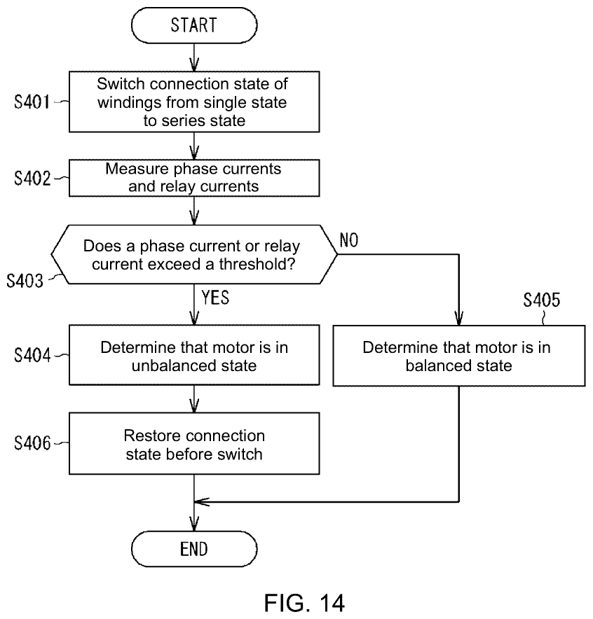

FIG. 14 is a flowchart depicting one example of the winding switching process performed by the control apparatus according to the fourth embodiment. Since steps S401 to S405 are the same as steps S101 to S105 in the first embodiment, description thereof is omitted. Note that it is assumed that the windings are connected in the single state.

### Step S406

When the abnormality detection unit has determined that the currents flowing through each phase of the AC motor are not balanced in response to the winding switching unit switching the connection state, the restoration unit 514 restores the winding switching unit to the state before the connection state was switched. As one example, when the winding switching unit 511 attempts to switch from the single state to the series state and the abnormality detection unit 513 has determined that the motor 20 is unbalanced (YES in step S403), the processing proceeds to step S404, and then the restoration unit 514 causes the winding switching unit 511 to switch the connection state back to the connection state before the switch (step S406). The winding switching process then ends.

In this example, since the winding switching unit 511 is attempting to switch the connection state of the windings from the single state to the series state, the connection state before the switch is the single state. For this reason, the restoration unit 514 causes the winding switching unit 511 to restore the connection state to the single state. Even if the relay 111u is stuck in the single state, by returning to the single state, the relay 112u will be set to off, which stops a large current flowing through the winding 21u. The V and W phases also return to the single state, so that the U, V, and W phases are all in the single state, placing the motor 20 in a balanced state where the motor 20 continues to operate normally. If the motor 20 has been installed in a vehicle, the vehicle can continue to run.

### Fifth Embodiment

The winding switching system according to the fifth embodiment further includes a notification unit. When the abnormality detection unit 513 has determined that the currents flowing through the respective phases of the AC motor are not balanced, the notification unit 516 notifies the user of the occurrence of an abnormality.

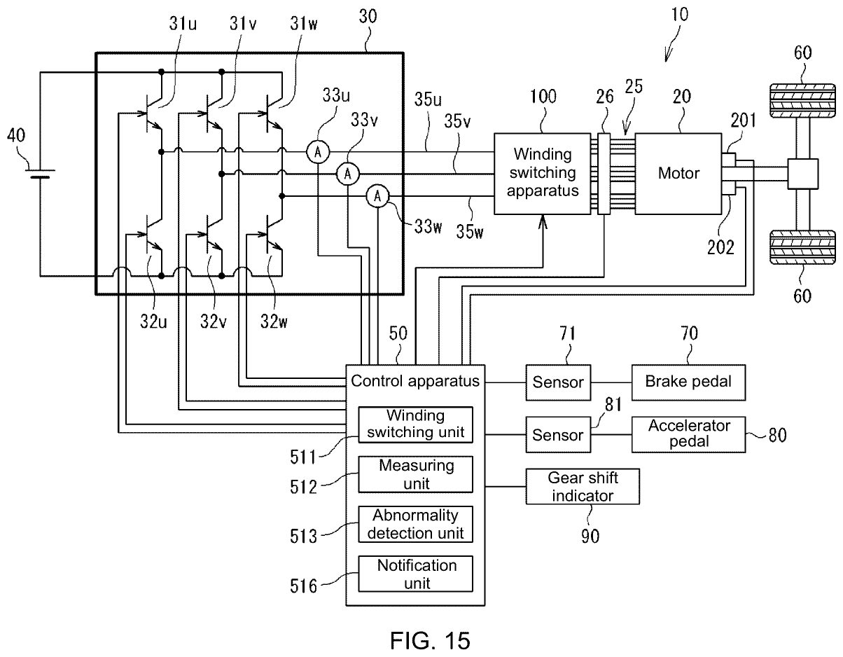

FIG. 15 is a circuit diagram depicting an example configuration of a winding switching system according to the fifth embodiment. A signal used by the notification unit 516 to notify the user is sound, light, or radio waves, for example. Notification with sound can be provided by a speaker, for example. Notification with light can be provided by a light-emitting diode, for example. Alternatively, notification can be provided by a liquid crystal display. Notification with radio waves can be provided by a wireless device, for example. The wireless device communicates with a smartphone and notifies the user via the smartphone. The speaker, light-emitting diode, liquid crystal display, and wireless device are provided in a vehicle, for example.

When the winding switching system is installed in a vehicle, the user of the vehicle can be informed that the motor 20 is in an unbalanced state using sound or light, or via a smartphone. The user who has informed that the motor 20 is in an unbalanced state can take appropriate measures, such as inspecting and repairing the motor.

### Sixth Embodiment

A winding switching system according to the sixth embodiment includes: a winding switching unit for switching a connection state of a plurality of windings of an AC motor capable of switching the connection state of the plurality of windings included on a stator of each phase; a measuring unit for measuring a physical quantity relating to rotation of the AC motor; a balance determination unit for determining whether currents flowing through respective phases of the AC motor are balanced based on the physical quantity measured by the measuring unit; and a restoration unit for causing, when a determination by the balance determination unit changes from a determination that the currents flowing through the respective phases are balanced to a determination that the currents flowing through the respective phases are not balanced in response to the connection state being having been switched from a first connection state to a second connection state, the winding switching unit to switch the connection state from the second state to the first connection state.

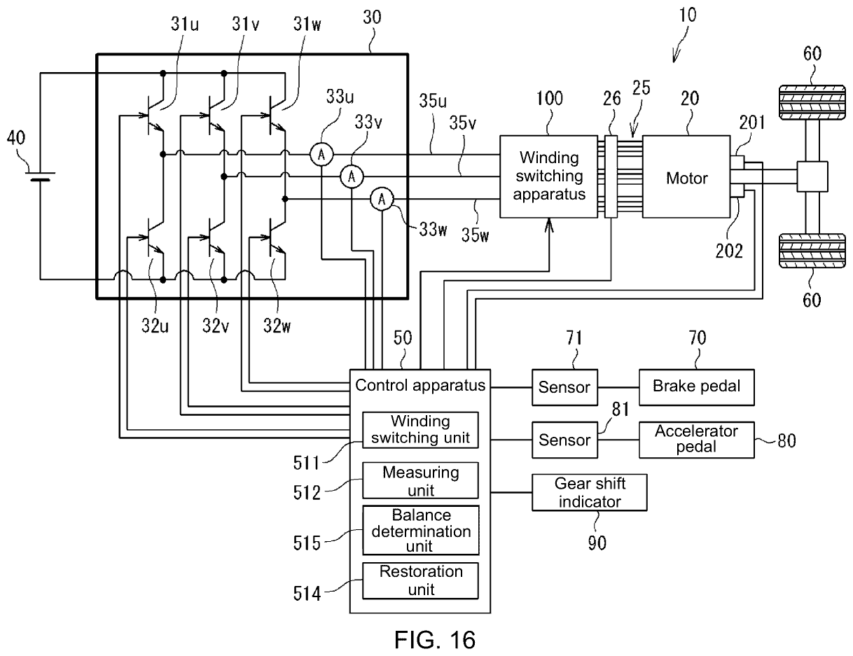

FIG. 16 is a circuit diagram depicting an example configuration of a winding switching system according to the sixth embodiment. The sixth embodiment differs from the first embodiment in that a balance determination unit 515 is provided in place of the abnormality detection unit 513, and the restoration unit 514 is also provided, but the other configurations are the same. Description of configurations that are the same as in the first embodiment is omitted and only different parts will be described, with the same reference numerals being used for configurations that are the same.

### Functions of Balance Determination Unit

The balance determination unit 515 determines whether the currents flowing through the respective phases of the AC motor are balanced based on a physical quantity measured by the measuring unit. The abnormality detection unit 513 of the first embodiment detects an abnormality that occurs in the winding switching apparatus 100 by determining whether the currents flowing through the respective phases of the AC motor are balanced. On the other hand, the balance determination unit 515 of the present embodiment is not configured to detect an abnormality. The restoration unit 514 is the same as the restoration unit 514 in the fourth embodiment.

### Operation of Winding Switching System

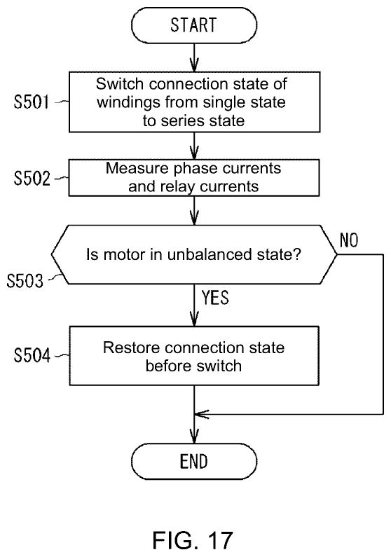

FIG. 17 is a flowchart depicting one example of a winding switching process performed by the control apparatus according to the sixth embodiment. Since steps S501 to S502 are the same as steps S101 to S102 in the first embodiment, description thereof is omitted. Note that it is assumed that the initial connection state of the windings is the single state.

### Step S503

The balance determination unit 515 determines whether the currents flowing through the respective phases of the motor 20 are balanced based on a physical quantity measured by the measuring unit 512. As one example, the balance determination unit 515 uses the received signals indicating the values of phase currents output by the phase current sensors 261u, 261v, and 261w and the received signals indicating the values of relay currents output by the relay current sensors 262u, 262v, and 262w to compare the phase currents or the relay currents measured by the measuring unit 512 with thresholds (step S503). If a threshold is exceeded (YES in step S503), it is determined that the motor 20 is unbalanced. The processing then proceeds to step S504. On the other hand, if a threshold is not exceeded (NO in step S503), it is determined that the motor 20 is in a balanced state. The winding switching process then ends.

### Step S504

When the determination by the balance determination unit has changed from a determination that the currents flowing through the respective phases are balanced to a determination that the currents flowing through the respective phases are not balanced in response to the connection state being switched from the first connection state to the second connection state, the restoration unit 514 causes the winding switching unit to switch the connection state from the second state to the first connection state (step S504). As one example, when the winding switching unit 511 attempts to switch from the single state to the series state and the balance determination unit 515 has determined that the motor 20 is unbalanced (YES in step S503), the restoration unit 514 causes the winding switching unit 511 to switch the connection state to the first connection state. The winding switching process then ends.

In this example, since the winding switching unit 511 attempted to switch the connection state of the windings from the single state to the series state, the connection state before the switch is the single state. Accordingly, the restoration unit 514 restores the connection state to the single state. Even if the relay 111u is stuck when in the single state, by returning to the single state, the relay 112u will be set to off, so that the large current flowing through the winding 21u stops. The V and W phases also return to the single state, so that the U, V, and W phases are all in the single state, which means that the motor 20 is in a balanced state and continues to operate normally. If the motor 20 is mounted in a vehicle, the vehicle can continue to run.

### Modifications

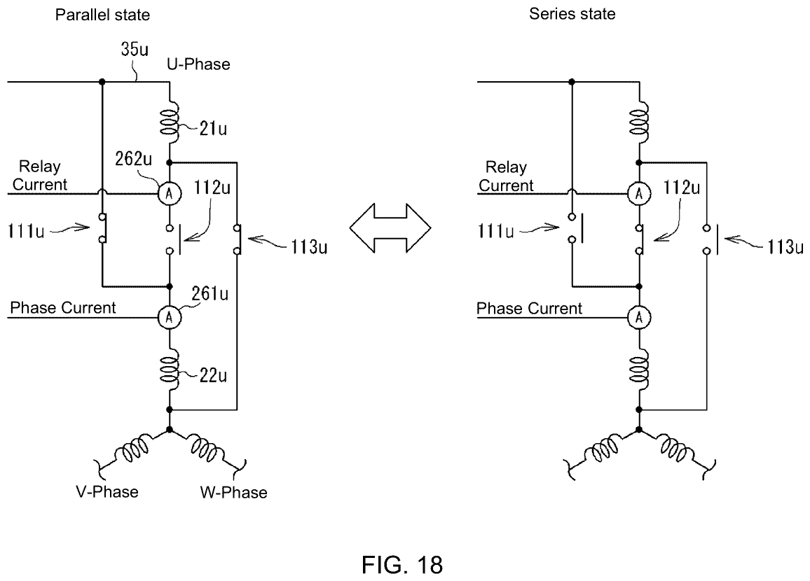

FIG. 18 depicts a modification of the winding switching apparatus 100. Although FIG. 18 depicts only the U-phase, the V and W-phases are the same. Compared to the first embodiment, a relay 113u is added. The relay 113u is set to on or off at the same timing as the relay 111u. The addition of the relay 113u enables the winding 21u and the winding 22u to be connected in parallel. Hereinafter, the case where the windings are connected in parallel may be referred to as the “parallel state”. When connecting the windings in parallel, the relays 111u and 113u are set to on, and the relay 112u is set to off. On the other hand, when connecting the windings in series, the relays 111u and 113u are set to off and the relay 112u is set to on.

The winding switching apparatus 100 switches the connection state of the windings of the motor 20 from the series state to the parallel state, or from the parallel state to the series state. When the windings are switched from the series state to the parallel state and the abnormality detection unit 513 has determined that the motor 20 is unbalanced, the restoration unit 514 restores the connection state of the windings to the series state. On the other hand, when the windings are switched from the parallel state to the series state and the abnormality detection unit 513 has determined that the motor 20 is unbalanced, the restoration unit 514 restores the connection state of the windings to the parallel state.

Note that although the restoration unit 514 is described here as restoring the motor to the parallel state or the series state when the abnormality detection unit 513 has determined that the motor 20 is in an unbalanced state, the motor may also return to the single state. As one example, a configuration may be used where the motor is restored to the single state if the unbalancing of the motor is not resolved even when the motor has been switched to either the parallel state or the series state. To restore the single state, the relay 112u is set to off, and one of the relays 111u and 113u is set to on. A configuration may also be used where if the unbalancing of the motor 20 is not resolved when one of the relays 111u and 113u has been set to on, the other relay is set to on.

### Appendix

The embodiments disclosed above are exemplary in all respects and should not be regarded as limitations on the present disclosure. The scope of the present disclosure is not limited to the embodiment given above, is indicated by the range of the patent claims, and is intended to include all changes within the meaning and scope of the patent claims and their equivalents.

1. A winding switching system comprising:
a winding switching unit for switching a connection state of a plurality of windings of an AC motor that includes the plurality of windings on a stator of each phase;
a measuring unit for measuring a physical quantity relating to rotation of the AC motor; and
an abnormality detection unit for determining whether currents flowing through respective phases of the AC motor are balanced based on the physical quantity measured by the measuring unit.

2. The winding switching system according to claim 1, wherein the winding switching unit switches the connection state of the plurality of windings using a plurality of relays.

3. The winding switching system according to claim 2, wherein the abnormality detection unit detects an abnormality that occurs at the plurality of relays by determining whether the currents flowing through the respective phases of the AC motor are balanced.

4. The winding switching system according to claim 1,
wherein the measuring unit includes a current sensor and measures the currents flowing through the respective phases using the current sensor, and
the abnormality detection unit determines that the currents flowing through the respective phases are not balanced when a current measured by the current sensor exceeds a threshold.

5. The winding switching system according to claim 4, wherein the current sensor measures a phase current flowing through the stator of each phase.

6. The winding switching system according to claim 4,
wherein at least one of the plurality of relays is a relay that is set to on in a first connection state and is set to off in a second connection state, and
the current sensor measures the current flowing through the relay that is set to on.

7. The winding switching system according to claim 1,
wherein the AC motor is a drive motor that drives wheels of a vehicle, and
the abnormality detection unit changes the threshold based on a required output of the AC motor.

8. The winding switching system according to claim 1,
wherein the measuring unit includes a current sensor that measures a phase current flowing through a stator of each phase, and measures a d-axis current and a q-axis current flowing through the AC motor based on the phase currents, and
the abnormality detection unit compares a target d-axis current, which is a target value of the d-axis current, and a target q-axis current, which is a target value of the q-axis current, with a measured d-axis current, which is a measured value of the d-axis current, and a measured q-axis current, which is a measured value of the q-axis current, and determines that the currents flowing through the respective phases are not balanced when at least one of a first condition that a difference between the target d-axis current and the measured d-axis current is equal to or greater than a first threshold and a second condition that a difference between the target q-axis current and the measured q-axis current is equal to or greater than a second threshold is satisfied.

9. The winding switching system according to claim 8,
wherein the AC motor is a drive motor that drives wheels of a vehicle, and
the abnormality detection unit changes at least one of the first threshold and the second threshold based on a required output of the AC motor.

10. The winding switching system according to claim 8, wherein the abnormality detection unit determines that the currents flowing through the respective phases are not balanced when at least one of a period during which the first condition is satisfied and a period during which the second condition is satisfied exceeds a reference value.

11. The winding switching system according to claim 10, wherein the abnormality detection unit changes the reference value based on a rotational speed of a rotor of the AC motor.

12. The winding switching system according to claim 1, wherein the measuring unit includes a voltage sensor that measures a voltage of the plurality of windings.

13. The winding switching system according to claim 1, wherein the measuring unit includes a sensor that measures output torque or a rotational speed of the AC motor.

14. The winding switching system according to claim 1, further including a restoration unit for causing the winding switching unit to restore the connection state before switching when the abnormality detection unit has determined that the currents flowing through the respective phases of the AC motor are not balanced in response to the winding switching unit switching the connection state.

15. The winding switching system according to claim 1, further comprising a notification unit that notifies a user of an occurrence of an abnormality when the abnormality detection unit has determined that the currents flowing through the respective phases of the AC motor are not balanced.

16. A winding switching system comprising:
a winding switching unit for switching a connection state of a plurality of windings of an AC motor capable of switching a connection state of the plurality of windings included on a stator of each phase;
a measuring unit for measuring a physical quantity relating to rotation of the AC motor;
a balance determination unit for determining whether the currents flowing through the respective phases of the AC motor are balanced based on the physical quantity measured by the measuring unit, and
a restoration unit for causing, when a determination by the balance determination unit changes from a determination that the currents flowing through the respective phases are balanced to a determination that the currents flowing through the respective phases are not balanced in response to the connection state having been switched from a first connection state to a second connection state, the winding switching unit to switch the connection state from the second state to the first connection state.

17. (canceled)

18. A control method for a winding switching apparatus comprising:
a winding switching step of switching a connection state of a plurality of windings of an AC motor that includes the plurality of windings on a stator of each phase;
a measuring step of measuring a physical quantity relating to rotation of the AC motor; and
an abnormality detection step of determining whether currents flowing through respective phases of the AC motor are balanced based on the physical quantity measured by the measuring step.

19. (canceled)
